(19) United States
(12) Patent Application Publication
(10) Pub. No.: US 2016/0078259 A1
(43) Pub. Date: Mar. 17, 2016

(54) SYSTEM AND METHOD FOR INTERACTION BETWEEN PHYSICAL OBJECTS AND DIGITAL APPLICATIONS

(71) Applicant: DIGITOYX, S.L., Madrid (ES)

(72) Inventor: Lucia GARATE MUTILOA, Friedrichshafen (DE)

(21) Appl. No.: 14/779,292

(22) PCT Filed: Mar. 19, 2014
(86) PCT No.: PCT/EP2014/055542

§ 371 Date: Sep. 22, 2015

Related U.S. Application Data
(60) Provisional application No. 61/804,624, filed on Mar. 23, 2013.

(51) Int. Cl. G06K 7/10; H04W 4/00

(52) U.S. Cl. CPC G06K 7/10366; H04W 4/008

(57) ABSTRACT

The present invention envisages a method and a system for interaction between physical objects and digital applications located, for example in mobile devices that comprises the steps of: a) the manufacturer generates an ID; b) stores the ID in a first storage element and c) attaches the first storage element to a physical object. Given that such storage elements has a low storage capability, the method envisages a step d) wherein the ID and a set of attributes of the physical object are stored in a server by a first device and a step e) wherein a second device communicates, by a digital application, with the server to retrieve the set of attributes stored therein.

### CROSS-REFERENCE TO RELATED APPLICATIONS

The present patent application is a national phase application of International Application No. PCT/EP2014/055542 filed Mar. 19, 2014, which claims priority to U.S. Provisional Application No. 61/804,624, filed Mar. 23, 2013, the disclosures of which are incorporated herein by reference.

### FIELD OF THE INVENTION

The invention relates to methods and systems for correlating characteristics of physical objects with virtual characteristics of such object defined by a digital application such as e.g., a mobile app.

### BACKGROUND

There is a problem of interaction between digital applications and physical objects. There are applications that require a seamless integration with the physical world, where accurate representations of the physical objects need to be used within digital applications.

Therefore, there is a problem of getting the information associated to the physical object into the digital application. There are an several combinations of the attributes that define a physical object, this attributes can be defined as a series of data of the physical object that need to be accessible to a digital application.

Prior art techniques for solving this kind of problem include storing the attributes of the object locally on the object itself by data storage elements such as radiofrequency identification tags (known in the art as RFID tags) or barcodes.

These storage elements include all of the information to be represented in the application.

The problem with this prior art techniques is that the amount of information that can be stored locally using these mediums is very limited.

Another prior art technique is assigning a common code to predefined objects and preloading in the application a set of physical objects and its predefined attributes. The problem of this solution is that changes on the physical or virtual attributes of the object cannot be modified and only the preloaded objects can interact with the application. There is no way of introducing new objects into the application that have not been preloaded.

### SUMMARY

The present invention discloses a method and a system wherein the application will load the attributes of the physical object from a cloud service, where information about the physical object is stored, including and not limited to a 3D model representation of the object. The way that the interaction is solved is by assigning a signed unique identification code to every object that can interact with the application. This unique identification code is a reference to the set of attributes stored in the cloud service. These set of attributes can then be loaded on the application during execution time.

In particular, the present invention discloses a method for interaction between physical objects and digital applications that comprises the steps of:
a) generate an identification code;
b) store the identification code generated in step a) in a first storage element being such first storage element a computer-readable storage element; and
c) attach the first storage element to a physical object;

wherein such method comprises a step d) wherein the identification code and a set of attributes of the physical object (for example, a set of attributes comprising a 3D model of the physical object) are stored in a server by a first device and a step e) wherein a second device communicates, by a digital application, with the server to retrieve the set of attributes stored therein.

Preferably, the method according to the present invention comprises a step f) wherein, step e) is performed once the second device, by the digital application, reads the identification code from the first storage element and sends it to the server.

Also, such method may comprise a step g) wherein the second device can add and/or modify attributes of the set attributes corresponding to the identification code read in step f).

Regarding the first storage element, such element may comprise an antenna for transferring the information stored therein to other devices. Such transfer of information can be done, preferably, by two ways: a first way where first storage element comprises wireless communication capability (for example, being an RFID tag o a device with near field communication (NFC) capabilities) or a second way wherein the first storage element comprises information that can be read visually (for example, being such first storage element a linear or bidimensional barcode). It should be noted that it can be considered as a storage element any element which contains information that can be detected by reading elements of the second device, such reading elements including and not limited to a camera, microphone, speaker, wireless antenna or touch sensor.

More preferably, in the method according to the present invention, the communication between the server, the first device and the server and the second device is done through Internet and the communication between the second device and the storage element located in the physical object is by near field communication elements (RFID, NFC, Zigbee, etc.).

Additionally, the present invention discloses a system for interaction between physical objects and digital applications that comprises:
a physical object comprising a first storage element wherein such first storage element stores an identification code provided by a first device;
a second device comprising a digital application;
a server comprising communication elements with the first device and the second device;

wherein the first device communicates with the server for storing a set of attributes corresponding to the identification code and wherein the digital application comprises elements for reading the first storage element and communicates with the server for retrieving the attributes corresponding to the identification code.

Preferably, in the system according to the present invention, the digital application communicates with the server and comprises elements for modifying at least one attribute of the set of attributes corresponding to the identification code. Additionally, the first device may also comprise elements for modifying at least one attribute of the set of attributes corresponding to the identification code.

Also, the first storage element may comprise an antenna for communication of the contents stored therein with other devices. This antenna allows a wireless communication, for example, RFID or NFC if a wireless communication module is added such as a near field communication module.

More preferably, such first storage may not comprise and antenna or wireless communication modules but may be read by image detection/analysis such as a barcode.

In a preferred embodiment, the server, the first device and the second device comprise an Internet communication module for communication amongst them.

Regarding the set of attributes, such set may comprise a 3D model of the physical object

### BRIEF DESCRIPTION OF THE FIGURES

In order to further explain the object of the invention and increase the comprehension of such invention, a preferred embodiment is disclosed together with a set of illustrative and non-limiting examples.

FIG. 1 shows a schematic view of a preferred embodiment according to the present invention.

FIG. 2 shows a schematic communication diagram of the steps to be performed in a preferred embodiment.

### DETAILED DESCRIPTION

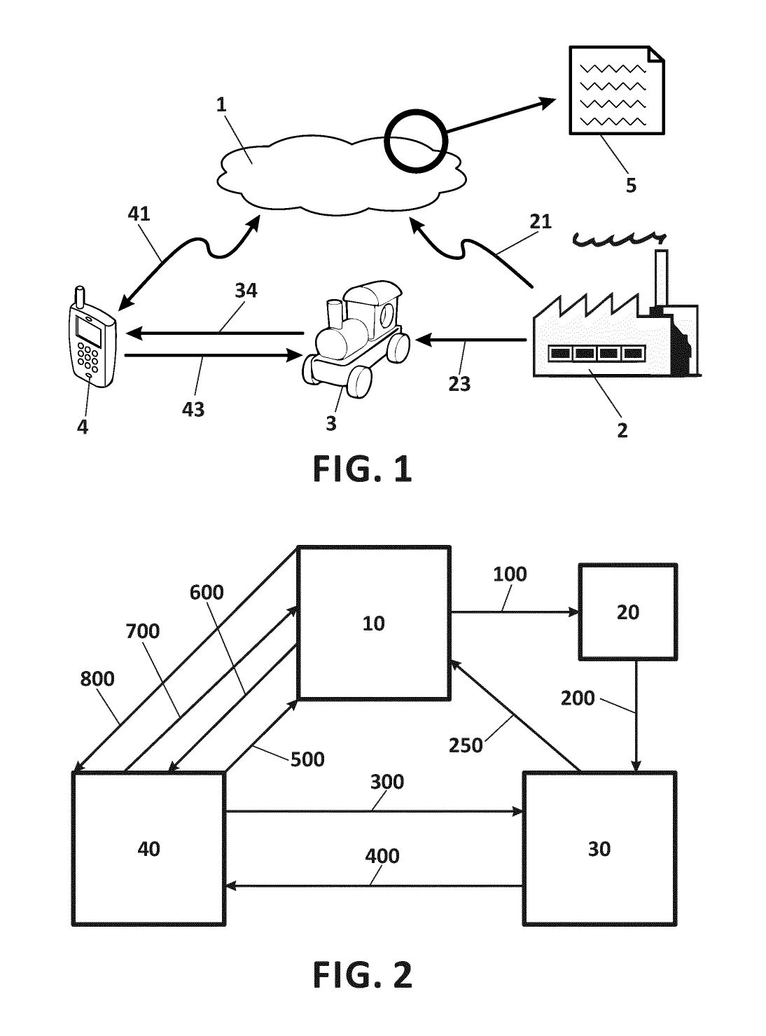

FIG. 1 shows a first embodiment wherein a cloud (1) represents a server with access to internet. Also, a manufacturer (2) of a physical object (3) and a mobile phone (4) which comprises a digital application are shown.

In the preferred embodiment of FIG. 1 it should be noted that the physical (3) object comprises several physical attributes, such as shape, material, dimensions, etc. Also, this physical object (3) comprises virtual attributes that can be, for example, manufacturing date, place of manufacturing, name, or attributes that can be associated to a digital application such as a game. In the case wherein some of the attributes are attributes related to games (or any digital application), examples of such attributes can be, for example, experience, type of device containing the digital application, weapons for the object, level, etc.

All of this attributes can be represented by digital elements such as a 3D modeling of the physical object (3), 3D representations of weapons, information regarding the level acquired by a user in a game, and all other types of information. However, as more attributes that are assigned to the physical object (3) more storage space is required and, if all of this information has to be stored in the physical object (3) so that it can be read from external devices, such as mobile phones (4), it would require a storage element that, not only can contain all of this information, but also comprises communication elements that allows it to transfer this information to the mobile phone (4).

Nevertheless, if all of this information is stored directly in the object (3) it could hardly be updated and expensive, high capacity storage elements are required.

The present invention provides that the manufacturer (2) of the physical object (3) attaches (23) a previously generated identification code (that is unique for each physical object (3)) to the physical object (3) wherein such identification code can be provided, e.g., in the form of a RFID tag, a device with NFC communication modules, etc. Such identification code may comprise low storage capacity since very little information will be stored therein.

Furthermore, the manufacturer (2) communicates via a first link (21) with a server that could be located in the cloud (1) and stores in such server the identification code together with a set of attributes (5) corresponding to the physical object such as, e.g., a 3D model of the object. This communication between the manufacturer and the server can be done trough Internet. Therefore the manufacturer (2) may comprise a device with communication capabilities an comprising such first link (21), preferably, being such first link connected to Internet by an Ethernet connection.

Therefore, in this method there is only a unique identification code stored within the physical object (3) and a set of attributes (5) for that object stored in the cloud (1).

On the other hand, there is provided that an electronic device, such as a mobile phone (4), comprise a digital application that uses the communication elements provided within the mobile phone (4) to read from the physical device (3) the unique identification code of the physical object (3). This can be done by image treatment techniques or by requesting via a second link (43) that the object emits its identification code which is then read (34) by the mobile phone (4). Preferably, this second link (43) and the subsequent data read (34) are envisaged to be a wireless links, e.g., using NFC or RFID standard.

Once the digital application of the mobile phone (4) has received the identification code, it communicates, via a third link (41) with the cloud (1) server to retrieve the set of attributes (5) that correspond to that unique identification code. Preferably, this third link (43) is envisaged to be a wireless Internet link, e.g., using 3G, LTE (Long term Evolution, or 4G, as known in the art) or WiFi standards.

Such set of attributes (5) can subsequently be used in the digital application for further processing and, also, a new set of attributes can be added to the physical object or the current set of attributes (5) may be modified.

FIG. 2 shows the communication scheme of an exemplary embodiment.

In particular, this figures envisages a scheme wherein the server is a cloud service (10), the identification code (or ID) is stored in an identification medium (20) with data storage capability and such data can be read by a device wirelessly (image treatment, wireless communications, etc.) and such identification medium is provided within a physical object (30).

On the other hand, a third-party device comprises a digital application (40) being such application able to read the identification code by means of modules provided within such device.

In a first step (100) the cloud service generates a unique ID which is stored in an identification medium. Then, in a second step (200) the identification medium is assigned to a physical object and preferably, such identification medium is attached to the physical object. In a fourth step (250) the attributes specific to that physical object are stored in the cloud service in association with the unique ID.

In a fifth step (300) the digital application scans the physical object looking for an appropriate medium with a valid ID stored. Once the digital application detects a valid ID, in a sixth step (400) the physical object delivers the unique ID assigned to it.

Then, in a seventh step (500) the digital application accesses the cloud service and provides the unique ID stored in the in the identification medium. Subsequently, in an eighth step (600) the cloud service returns to the digital application the specific attributes related to that unique ID, and therefore to that physical object. In a ninth step (700) the digital application sends to the cloud service updates on the attributes related to that unique ID, and therefore to that physical object according to actions made in the digital application related to that unique ID, for example, completing levels in a game.

Finally, in step (800) the cloud service returns a confirmation to the digital application for the update of the attributes related to that unique ID, and therefore to that physical object.

It should be noted that, although in the communications diagram of FIG. 2 it is not disclosed as such, not only the digital application (40) can retrieve, add and/or modify the attributes for an object, also, other devices may have access to the cloud service (10) for modifying and adding attributes to an object, e.g., the first device (2) of FIG. 1.

1. Method for interaction between physical objects and digital applications that comprises the steps of:
a) generate an identification code;
b) store the identification code generated in step a) in a first storage mean being such first storage mean a computer-readable storage mean; and
c) attach (23) the first storage mean to a physical object (3);
characterized in that it comprises a step d) wherein the identification code and a set of attributes (5) of the physical object (3) are stored in a server by a first device and a step e) wherein a second device (4) communicates with the server to retrieve the set of attributes (5) stored therein through a first communication link (41) by means of a digital application.

2. Method, according to claim 1, characterized in that it comprises a step f) wherein, step e) is performed once the second device (4), by the digital application, reads (34) the identification code from the first storage mean and sends it to the server.

3. Method, according to claim 2, characterized in that it comprises a step g) wherein the second device (4) adds and/or modifies attributes of the set attributes (5) corresponding to the identification code read (34) in step f).

4. Method, according to claim 1, characterized in that it comprises a step h) wherein the first device adds and/or modifies attributes of the set of attributes (5) corresponding to the identification code of the physical object (3).

5. Method, according to claim 1, characterized in that such first storage mean is a storage mean that comprises an antennae.

6. Method, according to claim 5, characterized in that such first storage device comprises wireless communication capability.

7. Method, according to claim 6, characterized in that such first storage device is a RFID tag.

8. Method, according to claim 6, characterized in that such first storage device has near-field communication capability.

9. Method, according to claim 1, characterized in that such first storage mean is a barcode.

10. Method, according to claim 1, characterized in that the server communicates with the first device via a second communication link (21) using Internet.

11. Method, according to claim 1, characterized in the server communicates with the second device (4) via a first communication link (41) using Internet.

12. Method, according to claim 1, characterized in that the set of attributes (5) comprise a 3D model of the physical object (3).

13. System for interaction between physical objects and digital applications that comprises:
a physical object (3) comprising a first storage mean wherein such first storage mean stores an identification code provided by a first device;
a second device (4) comprising a digital application;
a server (1) comprising a first communication link (41) with the second device (4) and a second communication link (21) with the first device;
wherein the first device communicates with the server for storing a set of attributes (5) corresponding to the identification code characterized in that the digital application comprises means for reading (34) the first storage mean and communicates with the server for retrieving the set of attributes (5) corresponding to the identification code.

14. System, according to claim 13, characterized in that the digital application communicates with the server (1) and comprises means for modifying at least one attribute of the set of attributes (5) corresponding to the identification code.

15. System, according to claim 13, characterized in that the first storage mean comprises an antenna.

16. System, according to claim 15, characterized in that the first storage device comprises a wireless communication module.

17. System, according to claim 13, characterized in that such first storage device is a RFID tag.

18. System, according to claim 16, characterized in that the wireless communication module is a near-field communication module.

19. System, according to claim 13, characterized in that such first storage mean is a barcode.

20. System, according to claim 13, characterized in that the server (1), the first device and the second device (4) comprise an Internet communication module.

21. System, according to claim 13, characterized in that the set of attributes (5) comprise a 3D model of the physical object (3)
